(19) United States
(12) Patent Application Publication
(10) Pub. No.: US 2005/0111409 A1
(43) Pub. Date: May 26, 2005

(54) Method and apparatus for mobile station registration in a cellular communication system

(76) Inventors: Stephen L. Spear, Skokie, IL (US); Mark E. Pecen, Palatine, IL (US); Jeffrey C. Smolinske, Schaumburg, IL (US); Lawrence A. Willis, McHenry, IL (US)

Correspondence Address: MOTOROLA, INC., 1303 EAST ALGONQUIN ROAD, IL01/3RD, SCHAUMBURG, IL, 60196, US

(21) Appl. No.: 10/721,668

(22) Filed: Nov. 25, 2003

(51) Int. Cl. H04Q 7/00

(52) U.S. Cl. 370/331; 370/338

(57) ABSTRACT

A communication system provides for a mobile station (MS) to pre-register with a Serving GPRS Support Node (SGSN) servicing a neighboring Routing Area (RA) that is a handoff candidate. In pre-registering with the neighboring RA and SGSN, the MS at least partially registers with the RA and SGSN, that is, at least a portion of the MS's registration information is conveyed to the neighboring SGSN serving the neighboring RA, prior to the MS being served by an associated neighboring BSS 230, for example, prior to an initiation of a handoff of the MS to neighboring BSS 230. By pre-registering with the candidate SGSN, a duration of a registration process and the corresponding service disruptions when the MS is handed off to such an SGSN are reduced.

### FIELD OF THE INVENTION

The present invention relates generally to cellular communication systems, and, in particular, to mobile station registration in a cellular communication system.

### BACKGROUND OF THE INVENTION

The General Packet Radio Service (GPRS) standard provides a compatibility standard for cellular mobile telecommunications systems. The GPRS standard ensures that a mobile station (MS) operating in a GPRS system can obtain communication services when operating in a system manufactured according to the standard. To ensure compatibility, radio system parameters and call processing procedures are specified by the standard, including call processing steps that are executed by an MS and a base station subsystem serving the MS in order to provide for cell reselection.

FIG. 1 is a block diagram of an exemplary GPRS communication system 100 of the prior art. Communication system 100 includes multiple Base Station Systems (BSSs) 110, 120. Each BSS 110, 120 includes a respective transceiver 112, 122 that is coupled to a respective controller 114, 124. Each BSS 110, 120 is coupled to a respective Serving GPRS Support Node (SGSN) 116, 126. In turn, each SGSN 116, 126 is further coupled to a Gateway GPRS Support Node (GGSN) 130 and, via the GGSN, to an external network 132. BSSs 110, 120, SGSNs 116, 126, and GGSN 130 are collectively referred to as an infrastructure of communication system 100. Communication system 100 further includes an MS 102 that resides in a first Routing Area (RA) and is provided communication services by a serving, or source, BSS 110 and a serving, or source, SGSN 116 serving the first RA. Typically, data is transferred between MS 102 and the serving BSS 110 over an air interface, or wireless communication link, 104 that includes a forward link and a reverse link.

As MS 102 moves around in communication system 100, the MS may experience deterioration in radio frequency (RF) signal conditions or congestion conditions with respect to the communication services provided to the MS by BSS 110. As a result, the MS 102 may decide to perform a cell reselection. In GPRS communication systems, such as communication system 100, the burden of cell selection is imposed on the MS. That is, in a GPRS communication system, the MS initiates a cell reselection and selects a target cell. During cell reselection, the MS may decide to abandon a serving RA, that is, the RA serviced by BSS 110 and SGSN 116, and to move to a neighboring, or target, RA, such as an RA serviced by BSS 120 and SGSN 126. In the current implementation of a GPRS system such as system 100, when MS 102 switches RAs, that is, is handed over from the source RA to the target RA, the MS establishes a wireless communication link 106 with the target BSS 120 serving the target RA and terminates the communication link 104 with the source RA. Upon establishing communication link 106, MS 102 must then register with the target SGSN 126 servicing the target RA.

Upon establishing communication link 106 with BSS 120, MS 102 ceases listening to the forward link associated with source BSS 110. As a result, MS 102 does not receive any data packets that may be conveyed by source BSS 110 to MS 102 subsequent to the MS establishing communication link 106 with target BSS 120. Any such data packets must be reconveyed to SGSN 126 and then conveyed by SGSN 126 to MS 102 via BSS 120. However, MS 102 must first register with SGSN 126 before the SGSN conveys any data packets to the MS. As a result, all data flows are put on hold while MS 102 registers with the new SGSN 126, which registration process may take several seconds. Initially, GPRS did not support real-time services and a data flow disruption of several seconds during cell reselection was not an important issue. However, as real-time services are added to GPRS communication systems, the need has arisen for minimizing the disruption to data flows during a cell reselection involving a switch of RAs.

Therefore, a need exists for a method and apparatus that reduces a length of time that data flows are disrupted during a cell reselection involving a switch of RAs in a GPRS communication system.

### BRIEF DESCRIPTION OF THE DRAWINGS

FIG. 1 is a block diagram of a wireless communication system of the prior art.

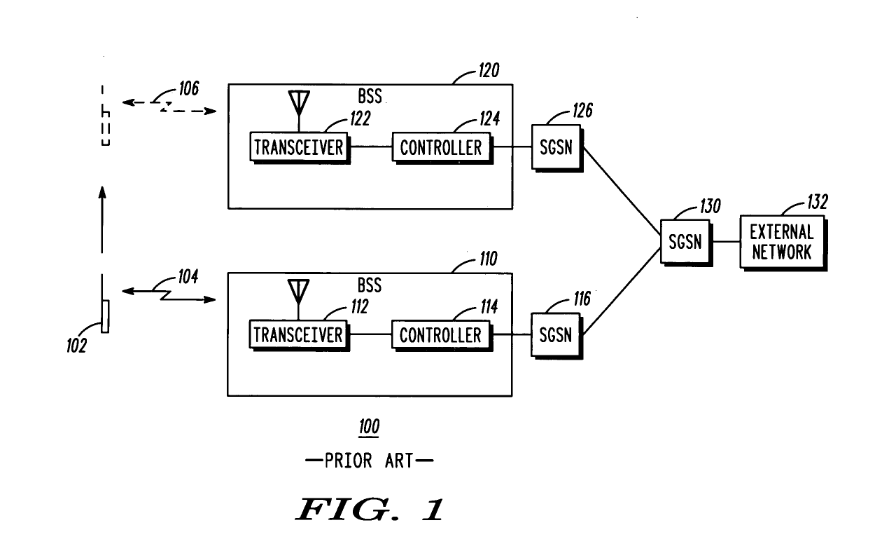

FIG. 2 is a block diagram of a wireless communication system in accordance with an embodiment of the present invention.

FIG. 3 is a logic flow diagram of a process by which a mobile station of FIG. 2 pre-registers with a potential target Serving GPRS Support Node (SGSN) of FIG. 2 in accordance with an embodiment of the present invention.

FIG. 4 is a block diagram of an exemplary, modified System Information message in accordance with an embodiment of the present invention.

FIG. 5 is a logic flow diagram of a mobile station-initiated pre-registration process in accordance with various embodiments of the present invention.

FIG. 6A is a logic flow diagram of an infrastructure-initiated pre-registration process in accordance with various embodiments of the present invention.

FIG. 6B is a continuation of the logic flow diagram of FIG. 6A depicting an infrastructure-initiated pre-registration process in accordance with various embodiments of the present invention.

### DETAILED DESCRIPTION OF THE INVENTION

To address the need for a method and apparatus that reduces a length of time that data flows are disrupted during a cell reselection involving a switch of Routing Areas (RAs) in a General Packet Radio Service (GPRS) communication system, a communication system provides for a mobile station (MS) to pre-register with a Serving GPRS Support Node (SGSN) servicing a neighboring Routing Area (RA) that is a handoff candidate. In pre-registering with the neighboring RA and SGSN, the MS at least partially registers with the RA and SGSN, that is, at least a portion of the MS's registration information is conveyed to the neighboring SGSN serving the neighboring RA, prior to the MS being served by an associated neighboring BSS 230, for example, prior to an initiation of a handoff of the MS to neighboring BSS 230. By pre-registering with the candidate SGSN, the duration of a registration process and the corresponding service disruptions when the MS is handed off to such an SGSN are reduced.

Generally, an embodiment of the present invention encompasses a method for registering a mobile station comprising registering the mobile station with a first Serving GPRS Support Node (SGSN), wherein the first SGSN services a first Base Station System (BSS) that provides communication services to the mobile station, assembling a Neighbor List that comprises a plurality of communication channels, wherein a communication channel of the plurality of communication channels is associated with a second BSS that is serviced by a second SGSN that is different than the first SGSN, and at least partially registering the mobile station with the second SGSN prior to the mobile station being served by the second BSS.

Another embodiment of the present invention encompasses an apparatus for pre-registering a mobile station, the apparatus comprising a first Serving GPRS Support Node (SGSN) having at least one memory device that maintains registration information concerning a mobile station and a processor operably coupled to the memory device that pre-registers the mobile station with a second SGSN, wherein the processor pre-registers the mobile station with the second SGSN prior to the mobile station being served by a Base Station System associated with the second SGSN.

Still another embodiment of the present invention encompasses a mobile station comprising at least one memory device and a processor operably coupled to the memory device that receives a Neighbor List, stores the Neighbor List in the at least one memory device, and conveys, to a Base Station System associated with a Serving GPRS Support Node, a request to pre-register the mobile station.

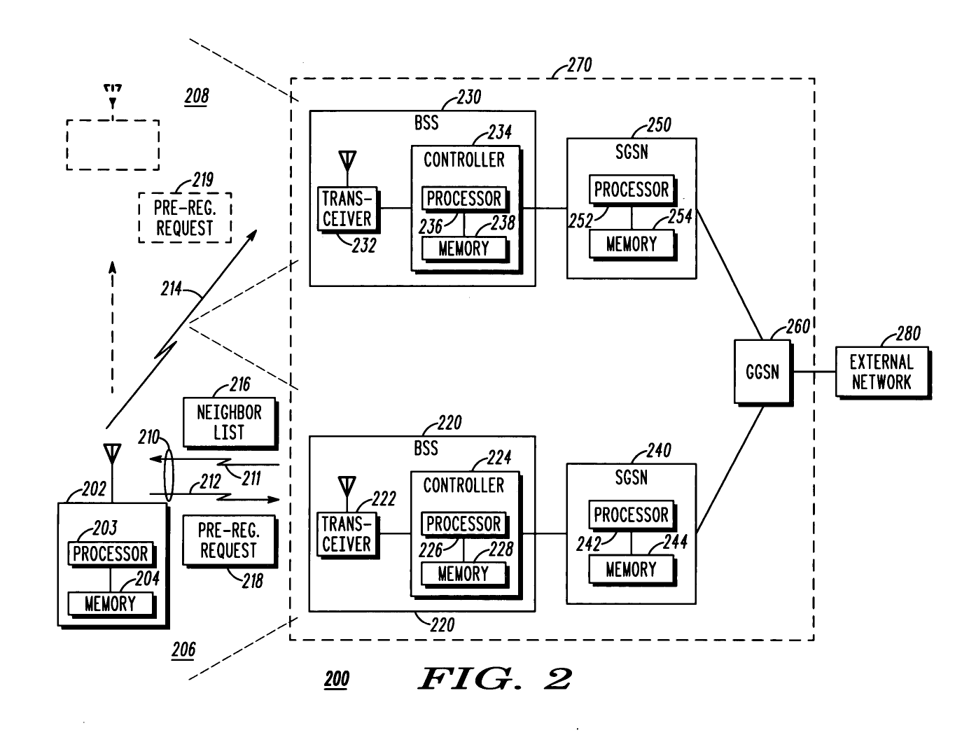

The present invention may be more fully described with reference to FIGS. 2-6B. FIG. 2 is a block diagram of a wireless communication system 200 in accordance with an embodiment of the present invention. Communication system 200 includes multiple Base Station Systems (BSSs) 220, 230 (two shown). Each BSS 220, 230, includes a respective at least one transceiver 222, 232, such as a Base Transceiver Station (BTS), that is operably coupled to a respective controller 224, 234. As is known in the art, each BSS 220, 230 may include elements such as a Base Station Controller (BSC), and a Packet Control Unit (PCU) or a Packet Control Function (PCF). When a BSS, such as BSS 220 or 230, includes such elements, controller 224 may be implemented in any one of such elements or may be distributed among such elements. Each BSS 220, 230 is coupled to a respective Serving GPRS Support Node (SGSN) 240, 250 by an interface, for example by a Gb interface or an Iu-ps interface, that includes a bearer path and a signaling interface. In turn, each SGSN 240, 250 is further coupled to a Gateway GPRS Support Node (GGSN) 260 and, via the GGSN, to an external network 280. BSSs 220, 230, SGSNs 240, 250, and GGSN 260 are collectively referred to as an infrastructure 270 of communication system 200.

Each SGSN 240, 250 provides communication services via an associated BSS 220, 230 to a respective Routing Area (RA) 206, 208. Communication system 200 further includes an MS 202 that resides in a first Routing Area (RA) 206 serviced by a first serving, or source, BSS 220 and a first serving, or source, SGSN 240. Data is transferred between MS 202 and serving BSS 220 via an air interface 210 that includes a forward link 211 and a reverse link 212. Forward link 211 comprises multiple communication channels including at least one broadcast channel, at least one traffic channel, and at least one control channel. Reverse link 212 also comprises multiple communication channels, including an access channel, at least one traffic channel, and at least one control channel.

Each of MS 202, controllers 224, 234 and SGSNs 240, 250 includes a respective processor 203, 226, 236, 242, 252 operably coupled to, or associated with, a respective at least one memory device 204, 228, 238, 244, 254. Each of processors 203, 226, 236, 242, and 252 comprises one or more microprocessors, microcontrollers, digital signal processors (DSPs), combinations thereof or such other devices known to those having ordinary skill in the art. Each of the at least one memory devices 204, 228, 238, 244, and 254 comprises at least one memory device such as a random access memory (RAM), a dynamic random access memory (DRAM), and/or a read only memory (ROM) or equivalents thereof, that maintains data and programs that may be executed by the corresponding processor. In addition, each of the at least one memory devices 244 and 254 of respective SGSNs 240 and 250 may further maintain a list of BSSs, such as BSSs 220 and 230, operating in communication system 200 in association with an SGSN, that is, SGSNs 240 and 250, servicing each BSS. Furthermore, each of the at least one memory devices 228 and 238 of respective controllers 224 and 234 and/or each of the at least one memory devices 244 and 254 of respective SGSNs 240 and 250 may further maintain a record of a geographical location of each BSS 220, 230 in communication system 200.

Communication system 200 comprises a wireless packet data communication system. In order for MS 202 to establish a packet data connection with an external network such as external network 280, each of MS 202 and multiple BSSs 220, 230, multiple SGSNs 240, 250, and GGSN 260 operates in accordance with the General Packet Radio Service (GPRS) standard, and in particular with 3GPP (Third Generation Partnership Project) TS (Technical Specification) 23.060 v5.0.0, 3GPP TS 44.060 v4.4.0, 3GPP TS 45.008 v5.4.0, 3GPP TS 04.18 v8.12.0, which standards are hereby incorporated by reference herein and copies of which may be obtained from the 3GPP via the Internet or from the 3GPP Organization Partners' Publications Offices at Mobile Competence Centre 650, route des Lucioles, 06921 Sophia-Antipolis Cedex, France. The GPRS standard specifies wireless telecommunications system operating protocols, including radio system parameters and call processing and handoff procedures, for GPRS communication systems. By operating in accordance with the GPRS standard, a user of MS 202 can be assured that MS 202 will be able to communicate with infrastructure 270 and establish a packet data communication link with an external network, such as network 280, via infrastructure 270. In communication system 200, a communication channel comprises one or more time slots of multiple time slots transmitted in a frequency bandwidth. However, those who are of ordinary skill in the art realize that communication system 200 may operate in accordance with any one of a variety of wireless packet data communication systems, such as a Global System for Mobile Communication (GSM) communication system, a Time Division Multiple Access (TDMA) communication system, a Code Division Multiple Access (CDMA) communication system, or an Orthogonal Frequency Division Multiple Access (OFDM) communication system.

Each controller 224, 234 maintains a record, in an associated at least one memory device 228, 238, of each MS that is active in communication system 200 and is serviced by the controller. Preferably, the controller maintains the records of active MSs by storing an MS identifier (MS ID) uniquely associated with each such MS in an associated at least one memory device 228, 238. For example, when MS 202 initiates a packet data session, the MS conveys a request for a channel assignment, preferably a Channel Request message, to a BSS servicing the MS, that is, BSS 220. The channel assignment request is received by BSS 220, and in particular transceiver 222, and forwarded to controller 224. In response receiving the request, controller 224 assigns to MS 202 one or more communication channels, including a traffic channel, in air interface 210 at transceiver 222 and conveys to transceiver 222 an Uplink Immediate Assignment (ULIA) message informing of the one or more assigned communication channels. Transceiver 222 then forwards the ULIA message to MS 202. Channel Request messages and ULIA messages are well known in the art and will not be described in detail herein. Upon receiving the ULIA message from BSS 220, MS 202 conveys a message including uplink data (UL Data) and an MS identifier (MS ID) uniquely associated with the MS, such as a Temporarily Logical Link Identifier (TLLI), to serving BSS 220. BSS 220 stores the received MS ID in the least one memory device 228 and forwards the message to associated serving SGSN 240.

Upon receiving the message, SGSN 240 stores the received MS ID in the at least one memory device 244 of the SGSN. SGSN 240 further establishes communication links between the SGSN and GGSN 260 for conveyance of data and other messages to and from MS 202, such as GPRS Tunneling Protocol (GTP) tunnels and flow identifiers for Packet Data Protocol (PDP) contexts. In addition, serving BSS 220 assembles and maintains, in the at least one memory device 244 and in association with MS 202, a Neighbor List 216 comprising communication channels associated with BSSs, such as BSS 230, that are potential handoff candidates for MS 202. In another embodiment of the present invention, Neighbor List 216 may be assembled by serving SGSN 240. BSS 220 or SGSN 240, whichever is appropriate, then conveys the assembled Neighbor List to MS 202. Upon receiving Neighbor List 216, MS 202 monitors one or more of the communication channels included in the Neighbor List.

As MS 202 moves around in communication system 200, the MS may experience deterioration in radio frequency (RF) signal conditions or congestion conditions with respect to the communication services provided to the MS by serving BSS 220. Alternatively, MS 202 may be informed of a preferred cell reselection candidate, such as a neighboring cell in target RA 208 and/or an associated neighboring BSS 230, by infrastructure 270. As a result, the MS 202 may decide to perform a cell reselection. During cell reselection, MS 202 may decide to abandon a first, source RA, that is, RA 206, and to move to a neighboring, target RA, such as a second RA 208 serviced by a second BSS 230 and a second SGSN 250.

In a prior art communication system such as communication system 100, when an MS is handed off from a first, source RA to a second, neighboring RA, and in particular from a first, source SGSN to a second, target SGSN, the MS must re-register in the second, neighboring RA, that is, with the second, target SGSN. The re-registration may cause a disruption in the data flow of several seconds and as many as seven to eight seconds, which disruption is unacceptable for real time services such as voice services. As. a result, communication system 200 provides for an MS, such as MS 202, to pre-register with an SGSN, such as SGSN 250, servicing a neighboring RA, that is, RA 208, that is a handoff candidate. In pre-registering in a neighboring RA 208 with SGSN 250, the MS at least partially registers with the SGSN, that is, at least a portion of the MS's registration information is conveyed to the neighboring SGSN serving the neighboring RA, prior to the MS being served by an associated neighboring BSS 230, for example, prior to an initiation of a handoff of the MS to neighboring BSS 230. By pre-registering with a potential target SGSN, the duration of a registration process and the corresponding service disruptions when the MS is handed off to such an SGSN are reduced.

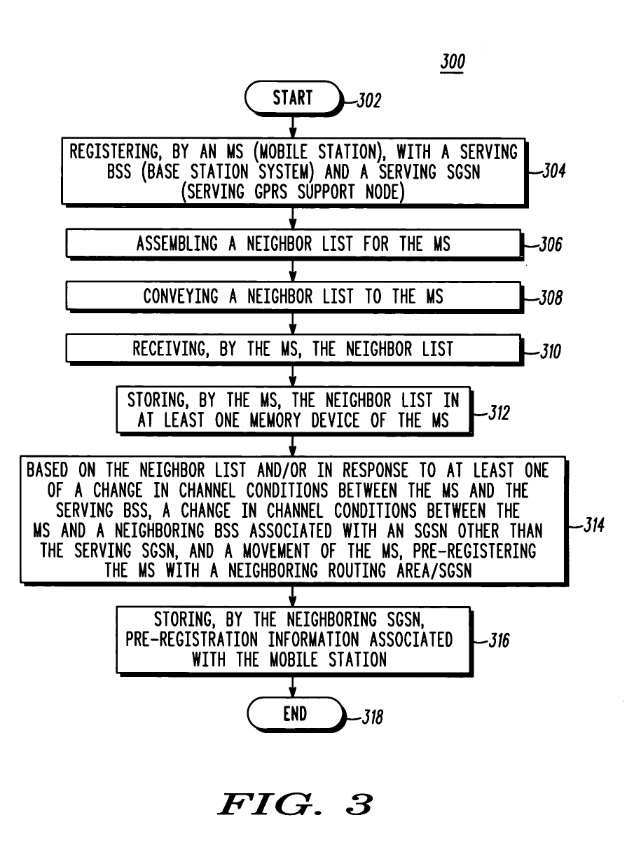

FIG. 3 is a logic flow diagram 300 of a process whereby an MS in communication system 200, such as MS 202, pre-registers in a potential target RA, and in particular with a potential target SGSN, such as SGSN 250, in accordance with an embodiment of the present invention. Logic flow diagram 300 begins (302) when an MS, such as MS 202, initially registers (304) with a serving BSS and a serving SGSN, that is, BSS 220 and SGSN 240. As part of the registration process, serving BSS 220, and in particular controller 224 of serving BSS 220, assembles (306) Neighbor List 216 and conveys (308) the assembled Neighbor List to MS 202. In another embodiment of the present invention, Neighbor List 216 may be assembled by serving SGSN 240 and conveyed by the SGSN to MS 202. Unless otherwise specified herein, all functions performed herein by MS 202, controller 224, controller 234, SGSN 240, or SGSN 250 are respectively performed by processor 203, 226, 236, 242, and 252. Furthermore, unless otherwise specified herein, all functions performed herein by BSS 220 or BSS 230 are respectively performed by controllers 224 and 234, and specifically by processors 226 and 236 of controllers 224 and 234.

In one embodiment of the present invention, Neighbor List 216 may be a typical Neighbor List of the prior art, comprising a list of broadcast channels (BCCH) associated with each of multiple neighboring BSSs, such as a broadcast channel associated with BSS 230. In such an embodiment of the present invention, each BSS of the multiple neighboring BSSs broadcasts information concerning an RA and or SGSN associated with the BSS via the associated broadcast channel. In response to receiving Neighbor List 216, MS 202 monitors the listed broadcast channels and receives the RA and/or SGSN information from each BSS included in the Neighbor List.

In another embodiment of the present invention, Neighbor List 216, in addition to including a list of broadcast channels (BCCH) associated with each of multiple neighboring BSSs, further includes, in association with each broadcast channel listed in the Neighbor List, an indicator of an RA or SGSN associated with the corresponding BSS. For example, in one embodiment of the present invention, Neighbor List 216 may include a single bit that indicates whether the BSS is a member of a same RA 206 as the first, serving or source, BSS 220. That is, from another perspective, Neighbor List 216 may indicate, for each listed broadcast channel, whether the corresponding BSS is serviced by a same SGSN as the SGSN 240 servicing the serving BSS 220. For example, Neighbor List 216 may include, in association with each listed broadcast channel, an RA membership data field. When the corresponding BSS is included in a same RA as source BSS 220, that is, is serviced by a same SGSN 240 as source BSS 220, then serving SGSN 240 may embed a value of ‘1’ in the RA membership data field. When the corresponding BSS is included in an RA, such as RA 208 with respect to BSS 230 and SGSN 250, different from the RA serviced by source BSS 220 and source SGSN 240, then serving SGSN 240 may embed a value of ‘0’ in the RA membership data field.

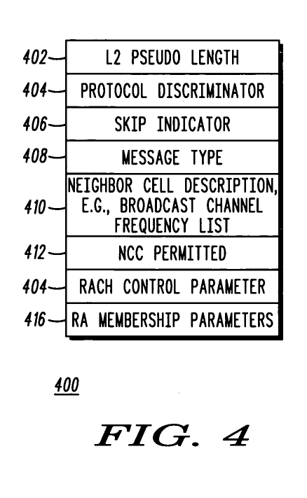

For example, Neighbor List 216 may be conveyed to MS 202 via a modified version of a System Information (SI) message, such as a modified SI 2, SI2bis, SI5, or an SI5bis message. In order to provide an indicator of an RA or SGSN associated with each BSS in the Neighbor List, infrastructure 270 may modify the SI message to include the RA or SGSN indicator. An example of such a modified SI message is depicted in FIG. 4. As shown in FIG. 4, an exemplary, modified SI message 400 may include a Layer 2 Pseudo Length data field 402, a Protocol Discriminator data field 404, a Skip Indicator data field 406, a Message Type data field 408, a Neighbor Cell Description data field 410 that informs of multiple neighbor cells and associated BSSs, such as a list of broadcast frequencies of each of multiple neighboring BSSs, a Network Colour Code (NCC) Permitted data field 412, and a Random Access Channel (RACH) Parameters data field 414. Such data fields are typical of an SI message. However, unlike a typical SI message, SI message 400 further includes an RA Membership data field 416 informing of an RA/SGSN associated with, or not associated with, each of the multiple neighbor cells and associated BSSs. SGSN 240 may then embed the RA/SGSN indicators in data field 416.

In another embodiment of the present invention, instead of an indicator indicating a ‘same’ or ‘different’ RA or SGSN, each indicator may comprise an identifier associated with the RA in which the corresponding BSS located or an identifier associated with the SGSN servicing the corresponding BSS. For example, the identifier may comprise a code that is uniquely associated with the RA or may comprise an identifier, such as a routing address such as an Internet Protocol (IP) address, that is uniquely associated with the SGSN. However, an advantage of using an indicator comprising a single bit is that a mere 16 bits, or two octets, are consumed in indicating an RA, or SGSN, associated with each of 16 broadcast channels typically included in a Neighbor List.

Referring again to FIG. 3, in response to receiving (310) Neighbor List 216, MS 202 stores (312) the received Neighbor List in the at least one memory device 204 of the MS. Based on Neighbor List 216 and/or in response to at least one of a change in channel conditions between MS 202 and BSS 220, a change in channel conditions between MS 202 and a neighboring BSS associated with an SGSN other than serving SGSN 240, such as BSS 230 and SGSN 250, and a movement of MS 202, MS 202 then pre-registers (314) in at least one RA, such as RA 208, and with an associated SGSN, that is, SGSN 250, that is associated with a BSS 230 corresponding to a channel in the Neighbor List and that is different than the RA 206/SGSN 240 associated with serving BSS 220. In pre-registering with a neighboring RA 208/SGSN 250, MS 202 at least partially registers with such an RA/SGSN prior to MS 202 being served by the associated neighboring BSS 230. In pre-registering MS 202 with neighboring RA 208/SGSN 250, at least a portion of the registration information associated with the MS is conveyed to, and received by, neighboring SGSN 250. In response to receiving the registration information, SGSN 250 stores (316) the registration information in the at least one memory device 254 of the SGSN and logic flow 300 then ends (318).

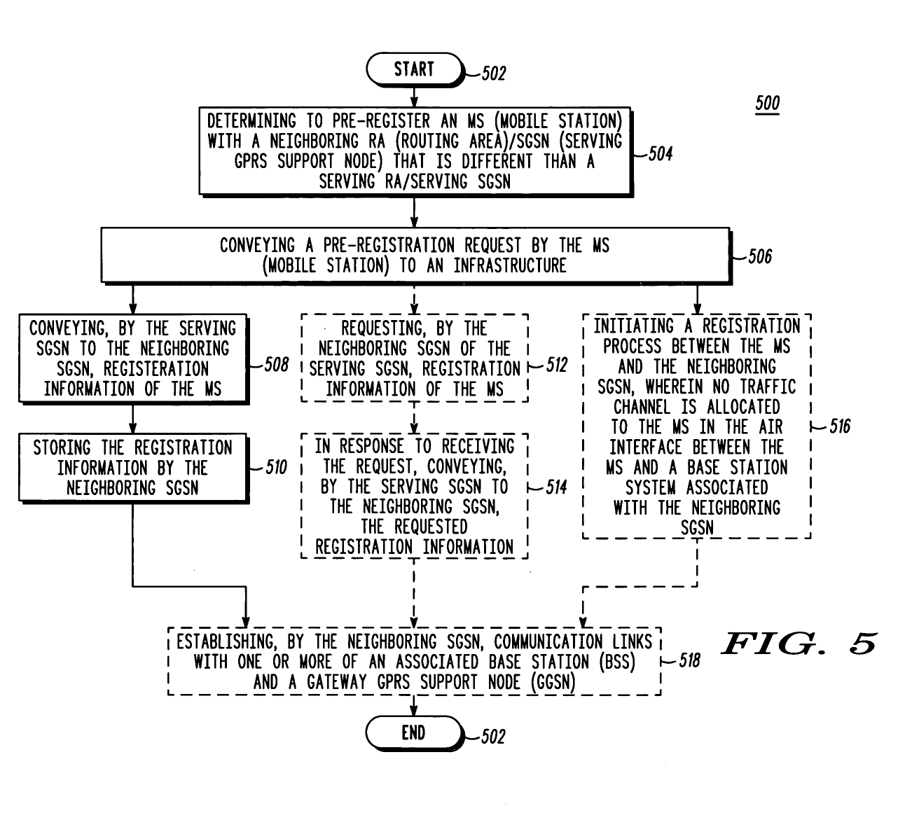

In one embodiment of the present invention, the step of pre-registering (314) with RA 208/SGSN 250 may be initiated by MS 202. FIG. 5 is a logic flow diagram 500 depicting an MS-initiated pre-registration in accordance with various embodiments of the present invention. Logic flow diagram 500 begins (502) when MS 202 determines (504) to pre-register with a neighbor SGSN, that is, SGSN 250. In one embodiment of the present invention, step 504 may comprise the following steps. In response to receiving Neighbor List 216, MS 202 determines whether any neighbor BSS, that is, a BSS associated with a communication channel in the Neighbor List, is further associated with an RA or SGSN different than the RA 206 or SGSN 240 associated with serving BSS 220. In response to determining that a BSS, such as BSS 230, associated with a communication channel in the Neighbor List is further associated with a neighbor RA or SGSN, such as RA 208 and SGSN 250, different than the serving RA 206 or serving SGSN 240, MS 202 determines to pre-register with the neighbor RA or SGSN.

In another embodiment of the present invention, step 504 may comprise the following steps. In response to receiving Neighbor List 216, MS 202 may monitor each broadcast channel identified in the Neighbor List. MS 202 determines a signal quality metric, such as a signal strength, a signal-to-noise ratio (SNR), or a bit error rate (BER), with respect to each monitored channel and compares each determined signal quality metric to a pre-registration signal quality metric threshold that is maintained in the at least one memory device 204 of the MS. When a determined signal quality metric compares favorably with the pre-registration signal quality metric threshold, for example, exceeds a signal strength threshold or a SNR threshold, then MS 202 determines to pre-register with a neighbor SGSN associated with the monitored broadcast channel and an associated BSS. MS 202 may further determine that the neighbor RA/SGSN is different than the serving RA/SGSN, or the serving SGSN, that is, SGSN 240, may determine that the neighbor RA/SGSN associated with the neighbor BSS is different than the serving RA/SGSN.

In response to determining to pre-register with a neighbor SGSN, that is, SGSN 250, MS 202 conveys (506) a pre-registration request to infrastructure 270. In one embodiment of the present invention, MS 202 may convey a pre-registration request to infrastructure 270 by conveying a first pre-registration request 218 to BSS 220 via the at least one control channel in reverse link 212, and via BSS 220 to serving SGSN 240. First pre-registration request 218 requests that infrastructure 270 pre-register MS 202 with neighbor SGSN 250. Pre-registration request 218 may specifically identify the neighbor SGSN, that is, SGSN 250, or an RA, that is, RA 208, associated with the neighbor BSS 230 and neighbor SGSN, or serving SGSN 240 may determine the neighbor SGSN by retrieving Neighbor List information stored in the at least one memory device 244 of the serving SGSN in response to receiving the pre-registration request.

In response to receiving pre-registration request 218, serving SGSN 240 conveys (508) registration information associated with MS 202 to the neighbor SGSN, that is, SGSN 250. In one embodiment of the present invention, serving SGSN 240 may convey to SGSN 250 at least a portion of the registration information associated with MS 202 and maintained by the serving SGSN in the at least one memory device 244. In another embodiment of the present invention, pre-registration request 218 may further include registration information intended for SGSN 250. In response to receiving pre-registration request 218, serving SGSN 240 forwards the received registration information to SGSN 250. In yet another embodiment of the present invention, in response to receiving pre-registration request 218, serving SGSN may request registration information from MS 202, for example, by conveying a registration request to MS 202. In response to receiving the registration request, MS 202 may convey registration information to SGSN 240, which registration information is forwarded by SGSN 240 to SGSN 250. Serving SGSN 240 may convey the registration information to SGSN 250 via GGSN 260 or, in response to receiving pre-registration request 218, may establish a point-to-point communication with SGSN 250 and convey the information via the established point-to-point communication. In response to receiving the registration information from SGSN 240, SGSN 250 stores (510) the registration information in the at least one memory device 254 of the SGSN. In addition, in response to receiving registration information for MS 202 from SGSN 240, SGSN 250 may also establish (518) communication links with BSS 230 and/or GGSN 260 for transmission of data to and from MS 202. Logic flow 500 then ends (520).

In another embodiment of the present invention, instead of conveying first pre-registration request 218 to serving BSS 20, MS 202 may convey a second pre-registration request 219 to neighbor BSS 230 via a control channel in a reverse link 214 between the MS and BSS 230, and via BSS 230 to SGSN 250. Second pre-registration request 219 requests that BSS 230 and associated SGSN 250 pre-register MS 202. In one embodiment of the present invention, second pre-registration request 219 may identify serving SGSN 240. In response to receiving pre-registration request 219, SGSN 250 may request (512), from serving SGSN 240, at least a portion of registration information associated with MS 202. The request maybe conveyed by SGSN 250 to SGSN 240 via GGSN 260 or via a communication link established between SGSN 250 and SGSN 240. In response to receiving the request for at least a portion of the registration information, SGSN 240 then conveys (514) the requested information to SGSN 250 and SGSN 250 stores the received registration information in the at least one memory device 254. In another embodiment of the present invention, second pre-registration request 219 may not identify SGSN 240. In such an embodiment of the present invention, in response to receiving the second pre-registration request, SGSN 250 may initiate (516) a pre-registration process with MS 202 that comprises steps of a typical registration process involving an exchange of registration information between MS 202 and SGSN 250. In yet another embodiment of the present invention, pre-registration request 219 may further include registration information associated with MS 202. In response to receiving pre-registration request 219, serving SGSN 250 stores the received registration information in the at least one memory device 254. Logic flow 500 then ends (520).

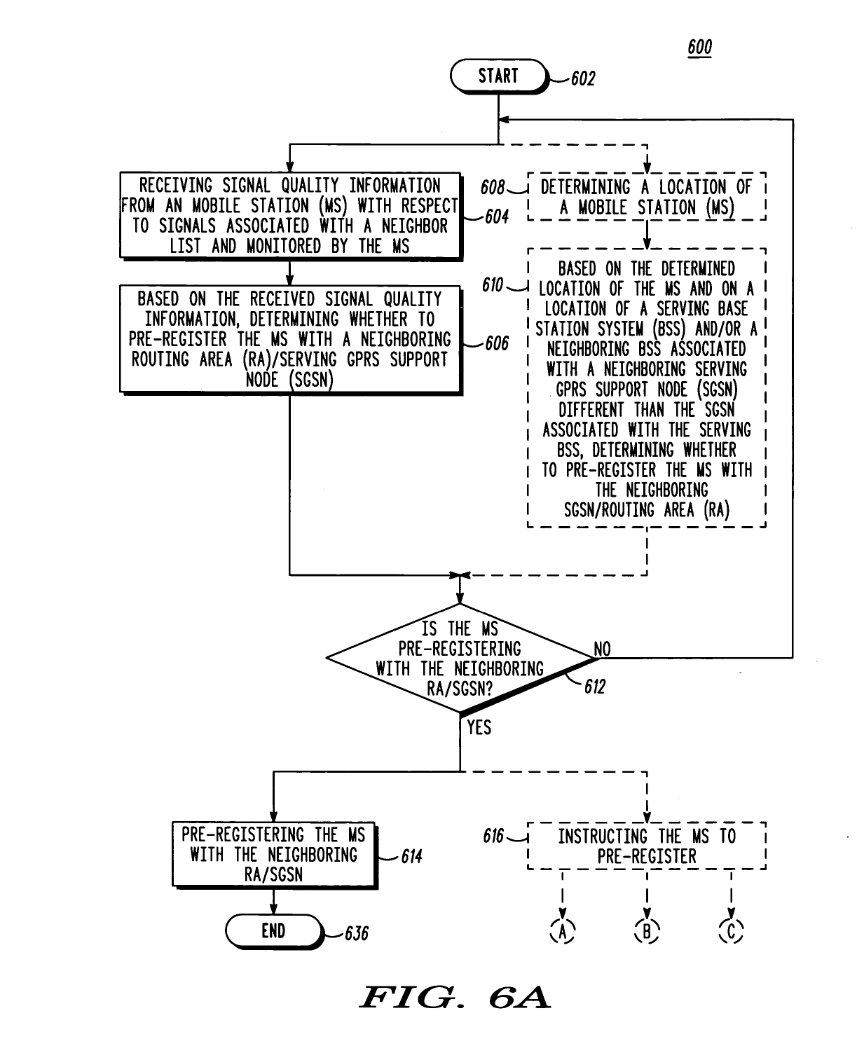

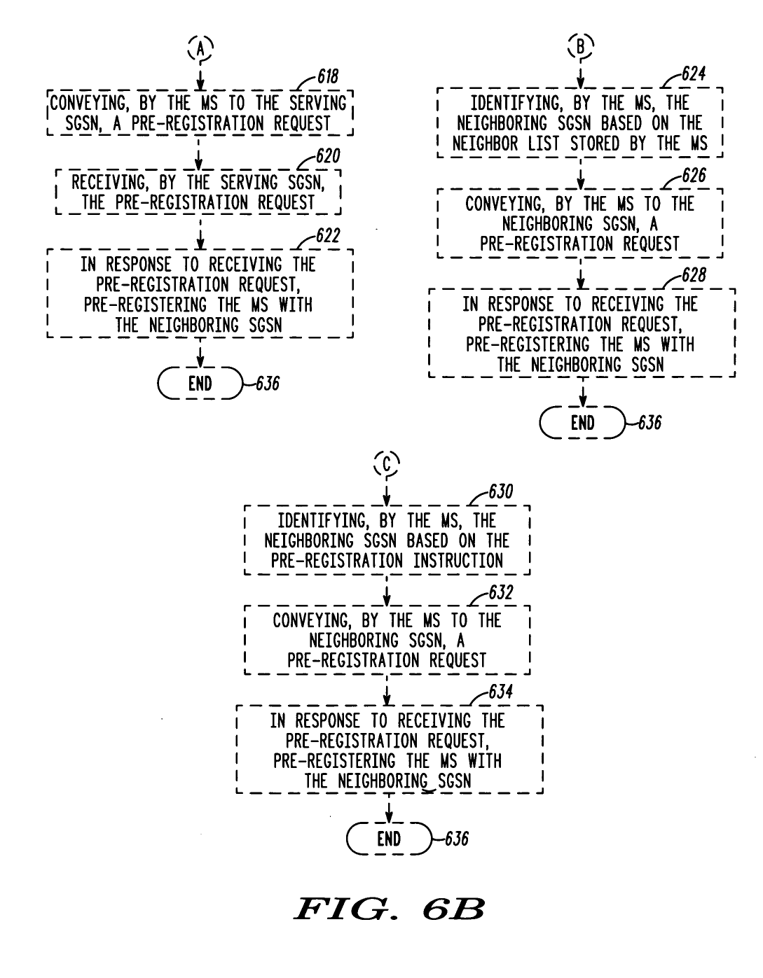

In each of the above embodiments of an MS initiated pre-registration, in addition to obtaining registration information concerning MS 202, neighboring SGSN 250 may also establish (518) communication links with BSS 230 and/or GGSN 260 for transmission of data to and from MS 202 as part of the pre-registration process. In still other embodiments of the present invention, the step of pre-registering (314) MS 202 with RA 208/SGSN 250 may be initiated by infrastructure 270. Referring now to FIGS. 6A and 6B, a logic flow diagram 600 is depicted of an infrastructure-initiated pre-registration in accordance with various embodiments of the present invention. In one embodiment of an infrastructure-initiated pre-registration process, logic flow diagram 600 begins (602) when infrastructure 270 receives (604), from MS 202, signal quality information corresponding to Neighbor List communication channels monitored by the MS. In one such embodiment, similar to the MS-initiated pre-registration embodiment, in response to receiving Neighbor List 216, MS 202 monitors each broadcast channel identified in the Neighbor List. MS 202 determines a signal quality metric, such as a signal strength, a signal-to-noise ratio (SNR), or a bit error rate (BER), with respect to each monitored channel and conveys the signal quality metrics to infrastructure 270 via serving BSS 220.

Based on the received signal quality information, serving BSS 220, and in particular serving controller 224, or serving SGSN 240 then determines (606) whether to pre-register MS 202 with a neighboring RA 208/SGSN 250 associated with a communication channel of Neighbor List 216. In one embodiment of the present invention, wherein infrastructure 270 receives signal quality metrics from MS 202, serving BSS 220 or serving SGSN 240 then compares each received signal quality metric to a pre-registration signal quality metric threshold. In another embodiment of the present invention, MS 202 may perform the comparison and convey the results of the comparison to infrastructure 270. When serving BSS 220 performs the comparison or receives comparison results from MS 202 and a determination of whether to pre-register MS 202 with a neighboring RA/SGSN resides in serving SGSN 240, the serving BSS conveys the comparison results to serving SGSN 240. When a determined signal quality metric compares favorably with the pre-registration signal quality metric threshold and serving BSS 220 or serving SGSN 240, whichever element of communication system 200 is making the pre-registration decision, further determines that the SGSN associated with the monitored signal, such as SGSN 250, is different than the serving SGSN, then the serving BSS or SGSN determines to initiate a pre-registration of MS 202 with such neighbor SGSN.

In another infrastructure-initiated embodiment of the present invention, serving BSS 220, and in particular serving controller 224, or serving SGSN 240 may determine whether to pre-register MS 202 based on a location of the MS. In such an embodiment, logic flow diagram 600 may begin (602) when a location of MS 202 is determined (608). In one such embodiment, MS 202 may self-determine its geographical location and convey the determined geographical location to infrastructure 270. Methods by which an MS may self-determine its geographical location are well-known in the art and will not be described in detail herein. For example, MS 202 may self-determine its geographical location based on location information received from each of multiple BSSs in communication system 200, such as based on a time difference of arrival (TDOA) of pilot signals received from each of the multiple BSSs. By way of another example, MS 202 may further include a Global Positioning System (GPS) receiver (not shown) and may self-determine its geographical location by reference to a constellation of GPS satellites. MS 202 then conveys its determined geographical location, or at least the received location information, to infrastructure 270 via serving BSS 220, which geographical location or location information is routed to SGSN 240 or to controller 224 of BSS 220.

Upon receiving the location information from MS 202, serving SGSN 240 or serving BSS 220 determines a geographical location of the MS based on the geographical location determined by MS 202 or based on the location information received from MS 202 and further retrieves the geographical locations of the BSSs associated with the Neighbor List of MS 202 from a respective at least one memory device 228, 244. When controller 224 determines the locations of MS 202 and/or BSSs 220 and 230, the controller may convey each such location determination to SGSN 240. Based on the determined locations of MS 202 and at least one of BSSs 220 and 230, serving BSS 220 or serving SGSN 240 then determines (610) whether to initiate a pre-registration of MS 202 with SGSN 250.

For example, serving BSS 220 or serving SGSN 240 may determine, based on multiple determinations of a geographical location of MS 202, that MS 202 is headed in a direction toward BSS 230. In response to determining that MS 202 is headed toward BSS 230, BSS 220 or SGSN 240 may determine (612) to initiate a pre-registration of MS 202 with SGSN 250. By way of another example, based on a determined location of MS 202 and BSS 230, BSS 220 or SGSN 240 may determine that MS 202 has moved to within a predetermined distance of BSS 230. In response to determining that MS 202 has moved to within the predetermined distance, BSS 220 or SGSN 240 may determine (612) to initiate a pre-registration of MS 202 with SGSN 250. By way of yet another example, the at least one memory device 228, 244 of BSS 220 or SGSN 240 may maintain a geographical location of a border, for handoff purposes, between a coverage area associated with BSS 220 and a coverage area associated with BSS 230. When BSS 220 or SGSN 240 determines that MS 202 has moved to within a geographical distance of the border, the BSS or SGSN may determine (612) to initiate a pre-registration of MS 202 with RA 208/SGSN 250.

In response to determining to initiate a pre-registration of MS 202 with RA 208/SGSN 250, BSS 220 or SGSN 240 may either instruct (616) the MS to pre-register or may pre-register (614) the MS with SGSN 250. In an embodiment of the present invention wherein serving BSS 220 or serving SGSN 240 pre-registers (614) MS 202 with RA 208/SGSN 250, serving BSS 220 may instruct serving SGSN 240 to pre-register MS 202, or serving SGSN 240 may on its own pre-register MS 202, with neighboring SGSN 250 as is described in detail above. For example, serving SGSN 240 may pre-register MS 202 by conveying to neighboring SGSN 250 at least a portion of the registration information associated with MS 202 and maintained in the at least one memory device 244 of the serving SGSN. Serving SGSN 240 may convey the information via GGSN 260 or may establish a point-to-point communication with SGSN 250 and convey the information via the established point-to-point communication.

In an embodiment of the present invention wherein BSS 220 or SGSN 240 instructs (616) the MS to pre-register, serving BSS 220 or serving SGSN 240 may convey a pre-registration instruction to MS 202 via the broadcast channel or the at least one control channel in forward link 211. The pre-registration instruction instructs MS 202 to pre-register. In one such embodiment, in response receiving the pre-registration instruction, MS 202 conveys (618) to serving SGSN 240 via serving BSS 220, and the serving SGSN receives (620) from the MS, a pre-registration request such as pre-registration request 218. In response to receiving the pre-registration request, serving SGSN 240 then pre-registers (622) MS 202 with neighbor SGSN 250 as described above, for example, by conveying to SGSN 250 registration information stored in the at least one memory device 244 of serving SGSN 240 or by forwarding registration information received by the serving SGSN from MS 202. Logic flow 600 then ends (636).

In another embodiment of the present invention, in response receiving the pre-registration instruction, MS 202 may identify (624) neighboring SGSN 250 or an associated RA 208 based on the Neighbor List maintained in the at least one memory device 204 of the MS and convey (626) a pre-registration request, such as pre-registration request 219, to the neighboring SGSN. In response to receiving the pre-registration request, neighboring SGSN 250 pre-registers (628) MS 202 as described above, for example, by obtaining registration information associated with MS 202 from SGSN 240, by engaging in a registration procedure with MS 202, or by storing registration information that may be included in the received pre-registration request. Logic flow 600 then ends (636).

In still another embodiment, the pre-registration instruction may include an identifier associated with neighboring SGSN 250. In response to receiving the pre-registration instruction, MS 202 identifies (630) neighboring SGSN 250 based on the received instruction and conveys (632) a pre-registration request to the neighboring SGSN. In response to receiving the pre-registration request, SGSN 250 pre-registers (634) MS 202 as described above and logic flow 600 then ends (636).

In each of the above embodiments, as part of the pre-registration of MS 202 with SGSN 250, SGSN 250 may further establish communication links with BSS 230 and/or GGSN 260 for transmission of data to and from MS 202.

By providing for a pre-registration of MS 202 with a neighboring SGSN 250 serving a neighboring RA 208 and a neighboring BSS 230 that are handoff candidates for MS 202, communication system 200 reduces a duration of a registration process and the corresponding service disruptions when the MS is handed off to such an RA and SGSN. In pre-registering in the neighboring RA 208 with SGSN 250, MS 202 at least partially registers with SGSN 250, that is, at least a portion of the MS's registration information is conveyed to the neighboring SGSN prior to the MS being served by an associated neighboring BSS 230, for example, prior to an initiation of a handoff of the MS to the neighboring BSS 230. In various embodiments of the present invention, the at least a portion of the MS's registration information may be conveyed by the serving SGSN 240 to the neighboring SGSN 250 in response to a self-initiated transfer by the serving SGSN or in response to a request received by the serving SGSN from MS 202 or from the neighboring SGSN. In other embodiments of the present invention, the at least a portion of the MS's registration information may be conveyed by MS 202 to neighboring SGSN 250 in response to a self-initiated pre-registration by the MS or in response to an instruction received by the MS from either serving BSS 220 or SGSN 240.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

1. A method for registering a mobile station comprising:
registering the mobile station with a first Serving GPRS Support Node (SGSN), wherein the first SGSN services a first Base Station System (BSS) that provides communication services to the mobile station;
assembling a Neighbor List that comprises a plurality of communication channels, wherein a communication channel of the plurality of communication channels is associated with a second BSS that is serviced by a second SGSN that is different than the first SGSN; and
at least partially registering the mobile station with the second SGSN prior to the mobile station being served by the second BSS.

2. The method of claim 1, wherein at least partially registering comprises conveying, by the first Serving GPRS Support Node (SGSN) to the second SGSN, at least a portion of registration information associated with the mobile station.

3. The method of claim 1, wherein at least partially registering the mobile station with the second Serving GPRS Support Node (SGSN) comprises:
receiving registration information from the mobile station; and
conveying the received registration information to the second SGSN.

4. The method of claim 1, wherein at least partially registering comprises:
receiving a request to pre-register the mobile station with the second Serving GPRS Support Node (SGSN); and
in response to receiving the request, conveying, by the first Serving GPRS Support Node (SGSN) to the second SGSN, at least a portion of registration information associated with the mobile station.

5. The method of claim 4, wherein receiving comprises receiving, by the first Serving GPRS Support Node (SGSN) from the mobile station, a request to pre-register the mobile station with the second SGSN.

6. The method of claim 4, wherein receiving comprises:
receiving, by the second Serving GPRS Support Node (SGSN) from the mobile station, a request to pre-register the mobile station with the second SGSN;
conveying, by the second SGSN to the first SGSN, a request for at least a portion of registration information associated with the mobile station;
receiving, by the first SGSN from the second SGSN, the request for at least a portion of the registration information; and
wherein conveying comprises, in response to receiving the request from the second SGSN, conveying, by the first Serving GPRS Support Node (SGSN) to the second SGSN, at least a portion of the registration information associated with the mobile station.

7. The method of claim 4, wherein receiving comprises receiving, by the first Serving GPRS Support Node (SGSN) from the first Base Station System (BSS), a request to pre-register the MS with the second SGSN.

8. The method of claim 1, wherein at least partially registering comprises conveying, by the mobile station to the second SGSN, at least a portion of registration information associated with the mobile station.

9. The method of claim 8, wherein conveying by the mobile station to the second Serving GPRS Support Node (SGSN) comprises conveying registration information to the first SGSN.

10. The method of claim 1, wherein at least partially registering comprises:
receiving, by the mobile station, an instruction to pre-register with the second Serving GPRS Support Node (SGSN); and
in response to receiving the instruction, conveying, by the mobile station to the second SGSN, at least a portion of registration information associated with the mobile station.

11. The method of claim 10, wherein conveying by the mobile station to the second Serving GPRS Support Node (SGSN) comprises conveying registration information to the first SGSN.

12. The method of claim 1, wherein the Neighbor List informs of a Routing Area (RA) associated with each communication channel of the plurality of communication channels and wherein at least partially registering comprises:
determining the second Base Station System (BSS) that is serviced by the second Serving GPRS Support Node (SGSN) that is different than the first SGSN based on the Routing Area associated with each communication channel of the plurality of communication channels included in the Neighbor List; and
at least partially registering the mobile station with the second SGSN based on the determined second BSS and prior to the mobile station being served by the second BSS.

13. The method of claim 1, wherein each communication channel of the plurality of communication channels is associated with a Base Station System (BSS) and wherein at least partially registering comprises:
broadcasting, by each BSS associated with a communication channel of the plurality of communication channels, information concerning a Routing Area associated with the BSS;
determining the second BSS that is serviced by the second SGSN that is different than the first SGSN based on the Routing Areas broadcast by each BSS associated with a communication channel of the plurality of communication channels; and
at least partially registering the mobile station with the second SGSN based on the determined second BSS and prior to the mobile station being served by the second BSS.

14. The method of claim 1, wherein at least partially registering comprises:
determining a signal quality metric for the communication channel of the plurality of communication channels that is associated with the second Base Station System (BSS);
determining to pre-register the mobile station with the second Serving GPRS Support Node (SGSN) based on the signal quality metric; and
at least partially registering the mobile station with the second SGSN prior to the mobile station being served by the second BSS.

15. The method of claim 1, wherein at least partially registering comprises:
determining a signal quality metric for a communication channel associated with the first Base Station System (BSS);
determining to pre-register the mobile station with the second Serving GPRS Support Node (SGSN) based on the signal quality metric; and
at least partially registering the mobile station with the second SGSN prior to the mobile station being served by the second BSS.

16. The method of claim 1, wherein at least partially registering comprises:
determining a signal quality metric for the communication channel of the plurality of communication channels that is associated with the second Base Station System (BSS);
determining to pre-register the mobile station with the second Serving GPRS Support Node (SGSN) based on the signal quality metric; and
at least partially registering the mobile station with the second SGSN prior to the mobile station being served by the second BSS.

17. The method of claim 1, wherein at least partially registering comprises:
determining a geographical location of the mobile station;
determining to pre-register the mobile station with the second Serving GPRS Support Node (SGSN) based on the determined location of the mobile station; and
at least partially registering the mobile station with the second SGSN prior to the mobile station being served by the second BSS.

18. The method of claim 17, further comprising determining a geographical location of the mobile station relative to a geographical location of the second Base Station System (BSS) and wherein determining to pre-register the mobile station comprises determining to pre-register the mobile station with the second Serving GPRS Support Node (SGSN) based on the determined location of the mobile station relative to the geographical location of the second BSS.

19. The method of claim 17, further comprising determining a coverage area associated with the second Base Station System (BSS) and wherein determining to pre-register the mobile station comprises determining to pre-register the mobile station with the second Serving GPRS Support Node (SGSN) based on the determined location of the mobile station relative to the coverage area associated with the second BSS.

20. The method of claim 17, further comprising determining a boundary between a coverage area associated with the first Base Station System (BSS) and a coverage area associated with the second BSS and wherein determining to pre-register the mobile station comprises determining to pre-register the mobile station with the second Serving GPRS Support Node (SGSN) based on the determined location of the mobile station relative to the boundary.

21. An apparatus for pre-registering a mobile station, the apparatus comprising a first Serving GPRS Support Node (SGSN) having a processor that pre-registers the mobile station with a second SGSN, wherein the processor pre-registers the mobile station with the second SGSN prior to the mobile station being served by a Base Station System associated with the second SGSN.

22. The apparatus of claim 21, wherein the processor pre-registers the mobile station by receiving registration information from the mobile station and conveying the received registration information to the second Serving GPRS Support Node (SGSN).

23. The apparatus of claim 21, wherein the processor pre-registers the mobile station by conveying registration information to the second Serving GPRS Support Node (SGSN) in response to receiving a request from a Base Station System (BSS) associated with the first SGSN to pre-register the mobile station.

24. The apparatus of claim 21, wherein the processor pre-registers the mobile station by receiving a request from the mobile station to pre-register the mobile station and, in response to receiving the request, conveying registration information to the second Serving GPRS Support Node (SGSN).

25. The apparatus of claim 24, wherein the first Serving GPRS Support Node (SGSN) further comprises at least one memory device that maintains the registration information and wherein conveying comprises, in response to receiving the request, conveying to the second SGSN at least a portion of the registration information maintained in the at least one memory device.

26. The apparatus of claim 24, wherein the pre-registration request identifies the second Serving GPRS Support Node (SGSN).

27. The apparatus of claim 24, wherein the first Serving GPRS Support Node (SGSN) identifies the second Serving GPRS Support Node (SGSN) in response to receiving the pre-registration request.

28. The apparatus of claim 21, wherein the processor pre-registers the mobile station by receiving a request from the second Serving GPRS Support Node (SGSN) to pre-register the mobile station and, in response to receiving the request, conveying registration information to the second SGSN.

29. The apparatus of claim 28, wherein the first Serving GPRS Support Node (SGSN) further comprises at least one memory device that maintains the registration information and wherein conveying comprises, in response to receiving the request, conveying to the second SGSN at least a portion of the registration information maintained in the at least one memory device.

30. The apparatus of claim 21, wherein the processor further assembles a Neighbor List corresponding to the mobile station and comprising a plurality of broadcast channels and wherein the Neighbor List comprises a Routing Area associated with at least one broadcast channel of the plurality of broadcast channels.

31. The apparatus of claim 21, wherein the apparatus further comprises a controller associated with a Base Station System serviced by the first Serving GPRS Support Node (SGSN), wherein the controller is in communication with the first SGSN, wherein the controller assembles a Neighbor List corresponding to the mobile station and comprising a plurality of broadcast channels, and wherein the Neighbor List comprises a Routing Area associated with at least one broadcast channel and of the plurality of broadcast channels.

32. The apparatus of claim 21, wherein the processor determines to pre-register the mobile station with the second Serving GPRS Support Node (SGSN) based on a quality of a communication channel associated with a Base Station System that is associated with the first SGSN.

33. The apparatus of claim 21, wherein the processor determines to pre-register the mobile station with the second Serving GPRS Support Node (SGSN) based on a quality of a communication channel associated with the Base Station System that is associated with the second SGSN.

34. The apparatus of claim 21, wherein the processor determines to pre-register the mobile station with the second Serving GPRS Support Node (SGSN) based on a location of the mobile station.

35. The apparatus of claim 21, wherein the apparatus further comprises the second Serving GPRS Support Node (SGSN), wherein the second SGSN receives registration information associated with the mobile station from the first SGSN and stores the received registration information in an at least one memory device of the second SGSN prior to the mobile station communicating with the second SGSN.

36. The apparatus of claim 35, wherein the second Serving GPRS Support Node (SGSN) conveys a request to the first SGSN to convey the registration information and, in response to conveying the request, receives the registration information from the first SGSN.

37. The apparatus of claim 36, wherein the second Serving GPRS Support Node (SGSN) receives a request from the mobile station to pre-register the mobile station and, in response to receiving the request, requests registration information associated with the mobile station from the first SGSN.

38. The apparatus of claim 35, wherein the second Serving GPRS Support Node (SGSN) further establishes a communication link with at least one of a Gateway GPRS Support Node (GGSN) and a Base Station System associated with the second SSGN prior to the mobile station communicating with the second SGSN.

39. The apparatus of claim 21, wherein the apparatus further comprises the second Serving GPRS Support Node (SGSN) and wherein the second Serving GPRS Support Node (SGSN) conveys a message to the mobile station informing of a Routing Area associated with the second SGSN and, in response to conveying the message informing of the Routing Area, receivers registration associated with the mobile station.

40. A mobile station comprising:
at least one memory device; and
a processor operably coupled to the memory device that receives a Neighbor List comprising a plurality of communication channels, stores the Neighbor List in the at least one memory device, and conveys to an infrastructure a request to pre-register the mobile station in a Routing Area associated with a communication channel of the plurality of communication channels prior to the mobile station being served by a Base Station System associated with the communication channel of the plurality of communication channels.

41. The mobile station of claim 40, wherein the Neighbor List comprises information concerning the Routing Area, wherein the Routing Area is different than a Routing Area associated with a serving Base Station System (BSS), and wherein the mobile station conveys the request to pre-register based on the Neighbor List.

42. The mobile station of claim 40, wherein the mobile station receives information concerning the Routing Area from the Base Station System (BSS) associated with the communication channel of the plurality of communication channels.

43. The mobile station of claim 40, wherein the processor conveys the pre-registration request to a serving Base Station System.

44. The mobile station of claim 40, wherein the processor conveys the pre-registration request to the Base Station System associated with the communication channel of the plurality of communication channels.

45. The mobile station of claim 40, wherein the processor further receives an instruction to pre-register and conveys the pre-registration request in response to receiving the instruction to pre-register.
